(19) United States
(12) Patent Application Publication
(10) Pub. No.: US 2024/0338435 A1
(43) Pub. Date: Oct. 10, 2024

(54) ATTACK ANALYSIS ASSISTANCE APPARATUS, ATTACK ANALYSIS ASSISTANCE METHOD, AND COMPUTER-READABLE RECORDING MEDIUM

(71) Applicant: NEC Corporation, Minato-ku (JP)

(72) Inventor: Yusuke TAKAHASHI, Tokyo (JP)

(73) Assignee: NEC Corporation, Minato-ku, Tokyo (JP)

(21) Appl. No.: 18/294,621

(22) PCT Filed: Aug. 30, 2021
(86) PCT No.: PCT/JP2021/031803

§ 371 Date: Feb. 2, 2024

(51) Int. Cl. G06F 21/55

(52) U.S. Cl. CPC G06F 21/552

(57) ABSTRACT

An attack analysis assistance apparatus includes: a comparison information extraction unit that extracts, from information regarding a plurality of targeted attacks, respective pieces of comparison information that are related to a set guideline and are to be used for comparison; and a similarity calculation unit that receives, as input, the pieces of comparison information extracted from the information regarding the plurality of targeted attacks, and calculates a similarity between the plurality of targeted attacks.

### TECHNICAL FIELD

The present disclosure relates to an analysis assistance apparatus and an attack analysis assistance method for assisting analysis of a cyberattack, and in particular relates to a computer-readable recording medium on which a program for realizing the apparatus and method is recorded.

### BACKGROUND ART

In recent years, the number of cyberattacks in the form of targeted attacks on corporations, government offices, organizations, and the like has increased. In a targeted attack, a target system is fraudulently entered, and exploitation, destruction, falsification, and the like of data are executed. In order to respond to such a targeted attack, it is important for a system administrator to analyze attack tactics and the like. Therefore, Patent Document 1 discloses an apparatus that assists with targeted attack analysis.

When malware is detected in a system, the apparatus disclosed in Patent Document 1 registers information regarding an attacker, attack tactics, a detection index, an observed event, an incident, and a response apparatus, and also displays the registered information. In addition, the apparatus disclosed in Patent Document 1 displays information in a manner hierarchized by type.

### LIST OF RELATED ART DOCUMENTS

### Patent Document

Patent Document 1: Japanese Patent Laid-Open Publication No. 2018-32355

### SUMMARY OF INVENTION

### Problems to be Solved by the Invention

Incidentally, as described above, in Patent Document 1, while it is possible to classify and present information regarding a targeted attack, simply classifying and presenting such information is insufficient in terms of responding to a targeted attack. In order to respond to a targeted attack, an administrator of a system needs to envision an attack similar to an actual targeted attack using analysis results, and perform exercises using the envisioned attack.

An example object of the present disclosure is to provide an attack analysis assistance apparatus, an attack analysis assistance method, and a computer-readable recording medium that enable quantitative presentation of a similarity between targeted attacks.

### Means for Solving the Problems

In order to achieve the above-described object, an attack analysis assistance apparatus includes:

a comparison information extraction unit that extracts, from information regarding a plurality of targeted attacks, respective pieces of comparison information that are related to a set guideline and are to be used for comparison; and

a similarity calculation unit that receives, as input, the pieces of comparison information extracted from the information regarding the plurality of targeted attacks, and calculates a similarity between the plurality of targeted attacks.

In order to achieve the above-described object, an attack analysis assistance method includes:

a comparison information extraction step of extracting, from information regarding a plurality of targeted attacks, respective pieces of comparison information that are related to a set guideline and are to be used for comparison; and

a similarity calculation step of receiving, as input, the pieces of comparison information extracted from the information regarding the plurality of targeted attacks, and calculating a similarity between the plurality of targeted attacks.

In order to achieve the above-described object, a computer readable recording medium according to an example aspect of the invention is a computer readable recording medium that includes recorded thereon a program,

the program including instructions that cause the computer to carry out:

a comparison information extraction step of extracting, from information regarding a plurality of targeted attacks, respective pieces of comparison information that are related to a set guideline and are to be used for comparison; and

a similarity calculation step of receiving, as input, the pieces of comparison information extracted from the information regarding the plurality of targeted attacks, and calculating a similarity between the plurality of targeted attacks.

### Advantageous Effects of the Invention

As described above, according to the invention, it is possible to present quantitatively a similarity between targeted attacks.

### BRIEF DESCRIPTION OF THE DRAWINGS

FIG. 1 is a configuration diagram showing a schematic configuration of the attack analysis assistance apparatus according to the example embodiment.

FIG. 2 is a configuration diagram showing a configuration of the attack analysis assistance apparatus according to the example embodiment in detail.

FIG. 3 is a diagram showing an example of attack information.

FIG. 4 is a diagram showing an example of comparison information and an approach for calculating a similarity when the guideline is functions executed in targeted attacks.

FIG. 5 is a diagram showing an example of comparison information and an approach for calculating a similarity when the guideline is timings when targeted attacks were executed.

FIG. 6 is a diagram showing an example of comparison information and an approach for calculating a similarity when the guideline is whether or not targeted attacks were executed successfully.

FIG. 7 is a flowchart showing operations of the attack analysis assistance apparatus according to the example embodiment.

FIG. 8 is a configuration diagram showing an application example of the attack analysis assistance apparatus according to the example embodiment.

FIG. 9 is a diagram showing an example of strategy information registered in a database according to an application example.

FIG. 10 is a diagram showing an example of technique information registered in a database according to an application example.

FIG. 11 is a diagram showing an example of software information registered in a database according to an application example.

FIG. 12 is a block diagram illustrating an example of a computer that realizes the attack analysis assistance apparatus 10 according to the example embodiment.

### EXAMPLE EMBODIMENT

### Example Embodiment

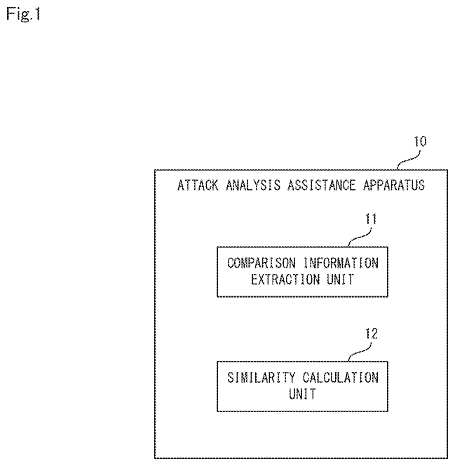

An attack analysis assistance apparatus according to an example embodiment will be described below with reference to FIGS. 1 to 12.

### [Apparatus Configuration]

First, a schematic configuration of the attack analysis assistance apparatus according to the example embodiment will be described with reference to FIG. 1. FIG. 1 is a configuration diagram showing a schematic configuration of the attack analysis assistance apparatus according to the example embodiment.

An attack analysis assistance apparatus 10 according to the example embodiment shown in FIG. 1 is an apparatus for assisting with cyberattack analysis. As shown in FIG. 1, the attack analysis assistance apparatus 10 includes a comparison information extraction unit 11 and a similarity calculation unit 12.

The comparison information extraction unit 11 extracts, from information regarding a plurality of targeted attacks, respective pieces of comparison information that are related to a set guideline and are to be used for comparison. The pieces of comparison information extracted from the information regarding the plurality of targeted attacks are input to the similarity calculation unit 12, which calculates a similarity between the plurality of targeted attacks.

In this manner, the attack analysis assistance apparatus 10 can calculate a similarity between a plurality of targeted attacks. That is to say, with the attack analysis assistance apparatus 10, it is possible to quantitatively present a similarity between targeted attacks.

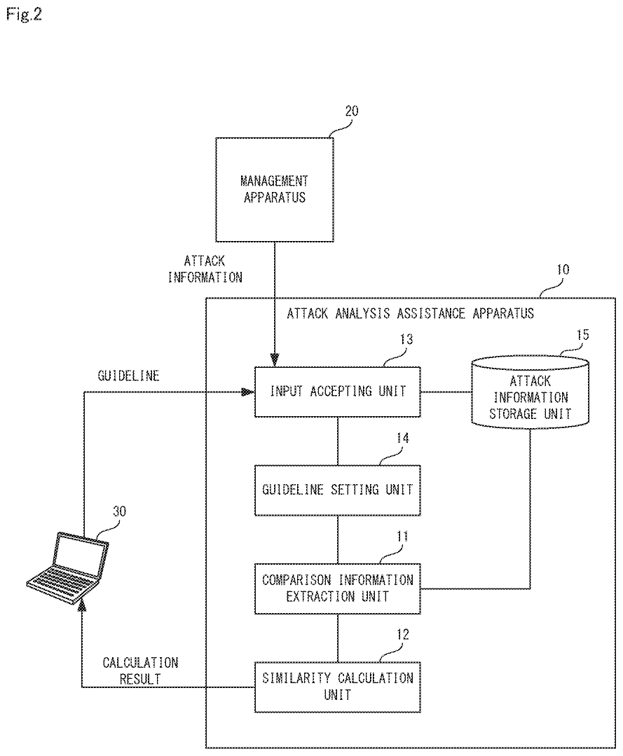

Subsequently, a configuration and functions of the attack analysis assistance apparatus 10 according to the example embodiment will be described in detail with reference to FIGS. 2 to 6.

FIG. 2 is a configuration diagram showing a configuration of the attack analysis assistance apparatus according to the example embodiment in detail.

As shown in FIG. 2, in the example embodiment, the attack analysis assistance apparatus 10 includes an input accepting unit 13, a guideline setting unit 14, and an attack information storage unit 15 in addition to the above comparison information extraction unit 11 and similarity calculation unit 12. In addition, the attack analysis assistance apparatus 10 is connected to a management apparatus 20 and a terminal apparatus 30 via a network so as to enable data communication.

The management apparatus 20 manages information regarding targeted attacks (hereinafter, referred to as “attack information”). The management apparatus 20 inputs the attack information managed by the management apparatus 20, to the attack analysis assistance apparatus 10. In addition, the attack information managed by the management apparatus 20 may include not only attack information regarding an actual targeted attack, but also attack information regarding a virtual targeted attack envisioned by the user. In this case, the user can check the degree of similarity between an actual targeted attack and a virtual targeted attack envisioned based on the actual targeted attack.

The terminal apparatus 30 is a terminal apparatus that is used by the user. When the user selects a guideline for attack analysis, the terminal apparatus 30 inputs the selected guideline to the attack analysis assistance apparatus 10. In addition, when a similarity is calculated by the attack analysis assistance apparatus 10 based on the guideline selected by the user, the terminal apparatus 30 receives the calculation result.

The input accepting unit 13 accepts attack information input by the management apparatus 20, and stores the accepted attack information in the attack information storage unit 15. In the example embodiment, the attack information may be information regarding an attack procedure in which functions executed in a targeted attack are defined in time series, information regarding execution of the targeted attack, and the like.

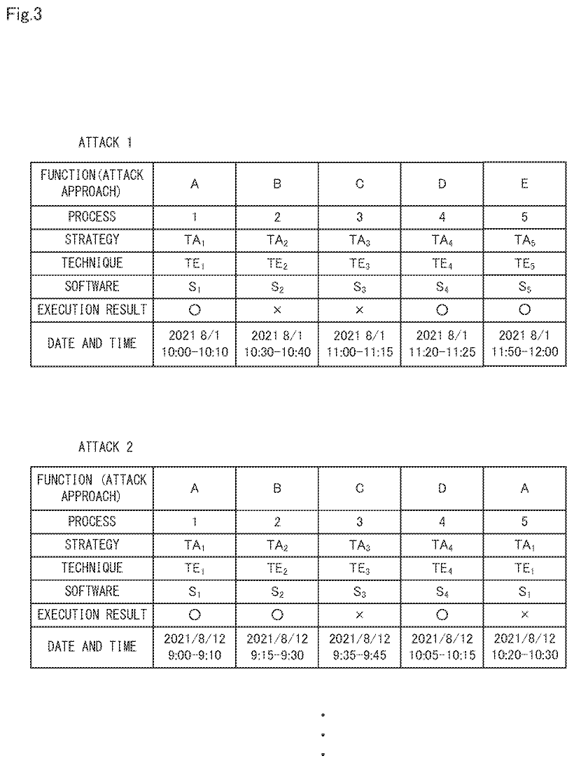

FIG. 3 is a diagram showing an example of attack information. In the example in FIG. 3, the attack information includes the above attack procedure in which functions executed in each targeted attack are defined in time series (hereinafter, also referred to as an “attack scenario”), and information regarding execution of the targeted attack. In addition, the attack information is managed according to each attack (an attack 1, an attack 2, . . . ).

Specifically, as shown in FIG. 3, each attack scenario is made up of functions (A, B, C, D, E . . . ) executed in the targeted attack and corresponding to processes (#=1, 2, . . . ) that make up the targeted attack. The functions refer to attack approaches used in the targeted attack, and include strategies (TA₁, TA₂, TA₃, . . . ) in the respective processes, techniques (TE₁, TE₂, TE₃, . . . ) used in the respective processes, and software (S₁, S₂, S₃, . . . ) required to execute processing in the processes.

Examples of a strategy include “Collection”, “Discovery”, “Lateral Movement”, and the like. A technique may be “Data from local System”, “Bypass user Account Control”, “Remote System Discovery”, or the like. Software may be “copy”, “nmap”, or the like. Note that “copy” indicates software that supports “Data from local System”, and “nmap” indicates software that supports “Remote System Discovery”.

In addition, in the example in FIG. 3, information regarding execution of each targeted attack includes execution results of the respective functions (attacking techniques), and times and dates when the functions were executed. An execution result is expressed as “successful” when a function is executed successfully and “not successful” when a function is not executed successfully.

In addition, when a guideline selected by the user is input to the terminal apparatus 30, the input accepting unit 13 receives the guideline input by the terminal apparatus 30. When input of the guideline is accepted by the input accepting unit 13, the guideline setting unit 14 sets the accepted guideline as a guideline that is used by the comparison information extraction unit 11 to extract comparison information. Examples of the guideline include functions (attack approach) executed in a targeted attack, a timing when the targeted attack was executed, whether or not the targeted attack was executed successfully, and the like.

When the user selects two or more guidelines and the two or more guidelines are input to the guideline setting unit 14 by the terminal apparatus 30, the guideline setting unit 14 sets the two or more guidelines as guidelines to be used to extract comparison information. Furthermore, when two or more guidelines are set, the guideline setting unit 14 sets a weight for each of the two or more set guidelines.

In the example embodiment, the comparison information extraction unit 11 extracts comparison information from attack information regarding attacks in accordance with a guideline set by the guideline setting unit 14. In addition, when the guideline setting unit 14 sets two or more guidelines, the comparison information extraction unit 11 extracts comparison information from attack information regarding the targeted attack, for each of the two or more guidelines.

The similarity calculation unit 12 calculates a similarity using the comparison information extracted from the attack information regarding the targeted attacks by the comparison information extraction unit 11. In addition, when the guideline setting unit 14 sets two or more guidelines, the similarity calculation unit 12 calculates similarities for the two or more respective guidelines, and then calculates an integrated similarity using the similarities and weights for the respective guidelines.

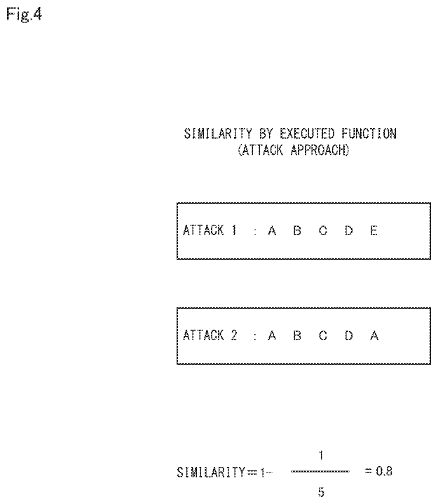

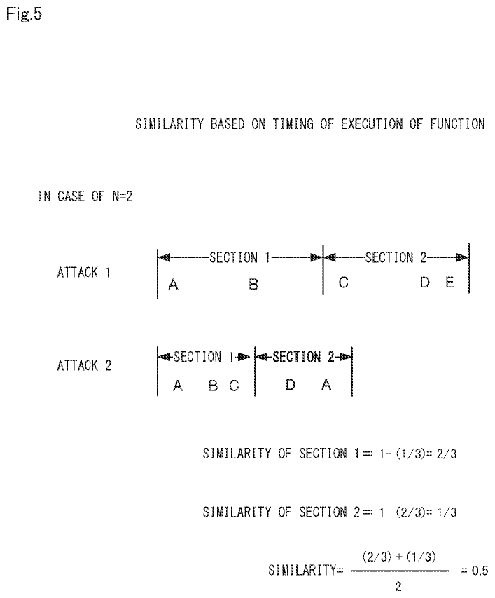

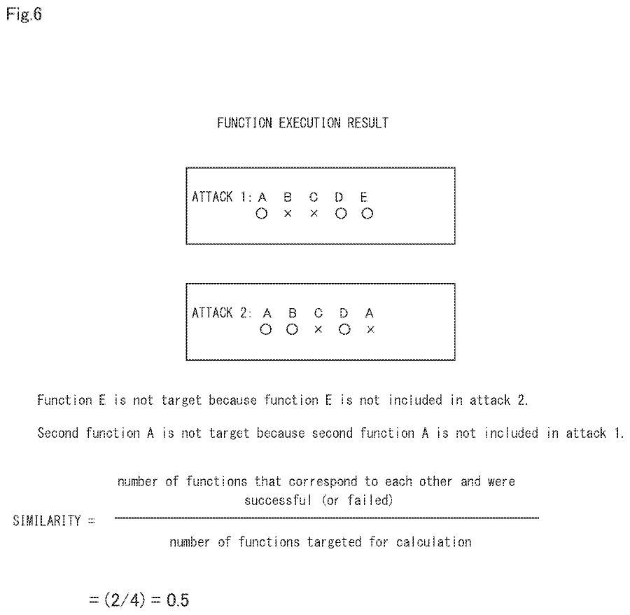

Functions of the comparison information extraction unit 11 and the similarity calculation unit 12 will be described in detail with reference to FIGS. 4 to 6. FIG. 4 is a diagram showing an example of comparison information and an approach for calculating a similarity when the guideline is functions executed in targeted attacks. FIG. 5 is a diagram showing an example of comparison information and an approach for calculating a similarity when the guideline is timings when targeted attacks were executed. FIG. 6 is a diagram showing an example of comparison information and an approach for calculating a similarity when the guideline is whether or not targeted attacks were executed successfully.

First, assume that functions (attack approaches) executed in targeted attacks are set as a guideline. In this case, as shown in FIG. 4, the comparison information extraction unit 11 extracts, as comparison information, information for specifying orders in which attack approaches were executed. Specifically, if the attack information is the information shown in FIG. 3, the comparison information extraction unit 11 extracts “A, B, C, D, E” with respect to the attack 1 and extracts “A, B, C, D, A” with respect to the attack 2 as comparison information.

In this case, the similarity calculation unit 12 calculates, as a similarity, a matching rate of the functions included in the attacks, or a similarity between the orders of the functions (similarity that is based on Levenshtein distance). As for the latter similarity, the similarity calculation unit 12 calculates the similarity using Expression 1 below, for example.

$$Similarity = 1 - \frac{Leven Shtein Distance ( Attack 1 , Attack 2 )}{Max Length ( Attack 1 , Attack 2 )} \qquad [ Expression 1 ]$$

In the example in FIG. 4, the attack 1 and the attack 2 each include five functions in total, one function of the five functions does not match the corresponding function of the other five functions, and thus the similarity is 0.8 (=1−(1/5)).

In addition, assume that timings when targeted attacks were executed are set as a guideline. In this case, as shown in FIG. 5, the comparison information extraction unit 11 extracts, as comparison information, information for specifying timings when functions were executed. Specifically, when a period from a time when the first function was executed to a time when execution of the last function ended is defined as an attack execution period, the comparison information extraction unit 11 divides the attack execution period into N (in FIG. 5, N=2) sections for each attack, and specifies functions executed in the respective sections. The comparison information extraction unit 11 then sets the specified functions in the respective sections for each attack, as comparison information. If the attack information is the information shown in FIG. 3, the comparison information extraction unit 11 extracts “section 1: A, B” and “section 2: C, D, E” with respect to the attack 1 and extracts “section 1: A, B, C” and “section 2: D, A” with respect to the attack 2, as comparison information.

In this case, the similarity calculation unit 12 calculates similarities for each section, and calculates the average value of the similarities in each section. In addition, the similarity calculation unit 12 calculates, as a similarity in each section, a matching rate between the functions executed in the corresponding section or a similarity between the order of functions in the corresponding sections (similarity that is based on Levenshtein distance). As for the latter similarity, the similarity calculation unit 12 calculates such similarities in the respective sections using Expression 1 above, and then obtains an average value, for example.

In the example in FIG. 5, the similarity between the sections 1 is 2/3, and the similarity between the sections 2 is 1/3. Accordingly, the average value of these similarities is obtained, which is 0.5. Note that a method for calculating a similarity is not limited, and a value other than an average value may be used as a similarity.

In addition, assume that whether or not targeted attacks were executed successfully is set as a guideline. In this case, as shown in FIG. 6, the comparison information extraction unit 11 extracts information for specifying the results of executing the functions as comparison information. Specifically, if the attack information is the information shown in FIG. 3, the comparison information extraction unit 11 extracts “A: successful, B: failed, C: failed, D: successful, E: successful” with respect to the attack 1 and extracts “A: successful, B: successful, C: failed, D: successful, A: failed” with respect to the attack 2 as comparison information.

In this case, the similarity calculation unit 12 calculates, as a similarity, a matching rate between execution results of corresponding functions in the attacks or a similarity between the orders of the functions (similarity that is based on Levenshtein distance). As for the former similarity, the similarity calculation unit 12 calculates such a similarity using Expression 2 below, for example.

$$SIMILARITY = \frac{\begin{matrix}number of functions that \\ correspond to each other \\ and were successful ( or failed )\end{matrix}}{\begin{matrix}number of functions targeted \\ for calculation\end{matrix}} \qquad [ Expression 2 ]$$

In the example in FIG. 6, the attack 2 does not include the function E, and thus the function E in the attack 1 is not targeted. In addition, the attack 1 does not include a second function A, and thus the second function A in the attack 2 is not targeted. Therefore, functions that correspond to each other and were successful (or failed) are the first functions A and the functions D, and thus the number of functions that correspond to each other and were successful (or failed) is four. In addition, the functions E and the second functions A are not targeted, and thus the number of functions that are targeted for calculation is four. Thus, the similarity is 0.5 (=2/4).

In addition, as described above, when the guideline setting unit 14 sets two or more guidelines, the similarity calculation unit 12 calculates similarities for the two or more respective guidelines, and applies the similarities and weights for the guidelines to Expression 3 below, to calculate an integrated similarity S. In Expression 3 below, w indicates a weight. The symbol f indicates a mathematical function for calculating a similarity for each guideline. Note that, in this case as well, the method for calculating a similarity is not limited.

$$\begin{matrix}S = \frac{{\sum }_{i = 1}^{n} {W}_{i} {f}_{i}}{{\sum }_{i = 1}^{n} {W}_{i}} & ( 0 \leq f \leq 1 )\end{matrix} \qquad [ Expression 3 ]$$

### [Apparatus Operations]

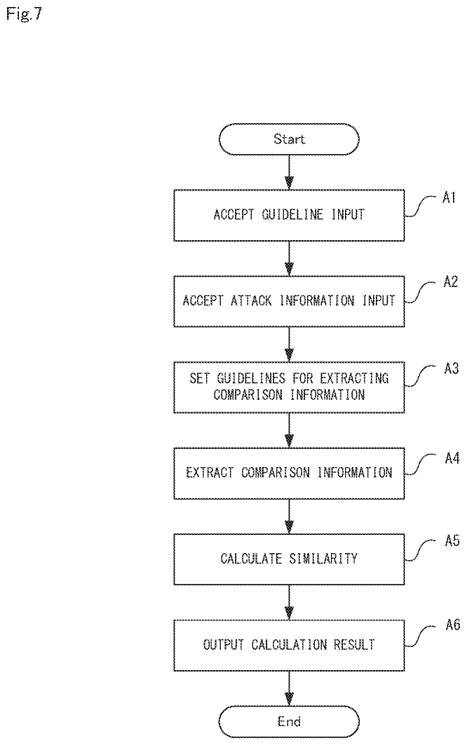

Next, operations of the attack analysis assistance apparatus 10 according to the example embodiment will be described with reference to FIG. 7. FIG. 7 is a flowchart showing operations of the attack analysis assistance apparatus according to the example embodiment. In the following description, FIGS. 1 to 6 are referenced as appropriate. In addition, in the example embodiment, an attack analysis assistance method is performed by causing the attack analysis assistance apparatus to operate. Thus, description of the attack analysis assistance method according to the example embodiment is replaced with the following description of the operations of the attack analysis assistance apparatus 10.

First, when a guideline selected by the user is input to the terminal apparatus 30, the input accepting unit 13 receives the guideline input by the terminal apparatus 30 (step A1).

Next, the input accepting unit 13 accepts attack information input by the management apparatus 20, and stores the accepted attack information in the attack information storage unit 15 (step A2).

Next, when input of the guideline is accepted in step A2, the guideline setting unit 14 sets the accepted guideline as a guideline that is used by the comparison information extraction unit 11 to extract comparison information, which will be described later (step A3).

In addition, when the user selects two or more guidelines, and the two or more guidelines are input from the terminal apparatus 30, the guideline setting unit 14 sets, in step A3, the two or more guidelines as guidelines that are used to extract comparison information. Furthermore, in this case, the guideline setting unit 14 sets weights for the two or more respective set guidelines.

Next, the comparison information extraction unit 11 extracts pieces of comparison information from attack information regarding respective attacks in accordance with the guideline set in step A3 (step A4). In step A4, when the guideline setting unit 14 sets two or more guidelines, the comparison information extraction unit 11 extracts pieces of comparison information from attack information regarding respective targeted attacks, for each of the two or more guidelines. Examples of comparison information that is extracted are shown in FIGS. 4 to 6.

Next, the similarity calculation unit 12 calculates a similarity using the comparison information extracted from the attack information regarding the attacks in step A4 (step A5). When two or more guidelines are set in step A3, the similarity calculation unit 12 calculates similarities for the two or more respective guidelines as shown in FIGS. 4 to 6, and calculates an integrated similarity using the similarities and weights for the respective guidelines.

The similarity calculation unit 12 then outputs the calculation result of the similarity calculated in step A5, to the terminal apparatus 30 of the user (step A6).

By executing steps A1 to A6, the user can obtain a similarity between targeted attacks in accordance with a guideline selected by the user. Therefore, the user can easily envision an attack similar to an actual targeted attack, and perform exercises using the envisioned attack.

### [Program]

It is sufficient that a program according to an example embodiment is a program that causes a computer to execute steps A1 to A6 shown in FIG. 7. By installing this program to a computer, and executing the program, it is possible to realize the attack analysis assistance apparatus 10 and an attack analysis assistance method according to this example embodiment. In this case, a processor of the computer functions as the comparison information extraction unit 11, the similarity calculation unit 12, the input accepting unit 13, and the guideline setting unit 14, and performs processing. The computer may be a general-purpose PC, or may be a smartphone or a tablet terminal apparatus.

In addition, in the example embodiment, the attack information storage unit 15 may be realized by storing, in a storage device such as a hard disk that is included in a computer, a data file that makes up these, or may be realized by a storage device of another computer.

In addition, the program according to this example embodiment may be executed by a computer system constructed using a plurality of computers. In this case, for example, each computer may function as one of the comparison information extraction unit 11, the similarity calculation unit 12, the input accepting unit 13, and the guideline setting unit 14.

### Application Examples

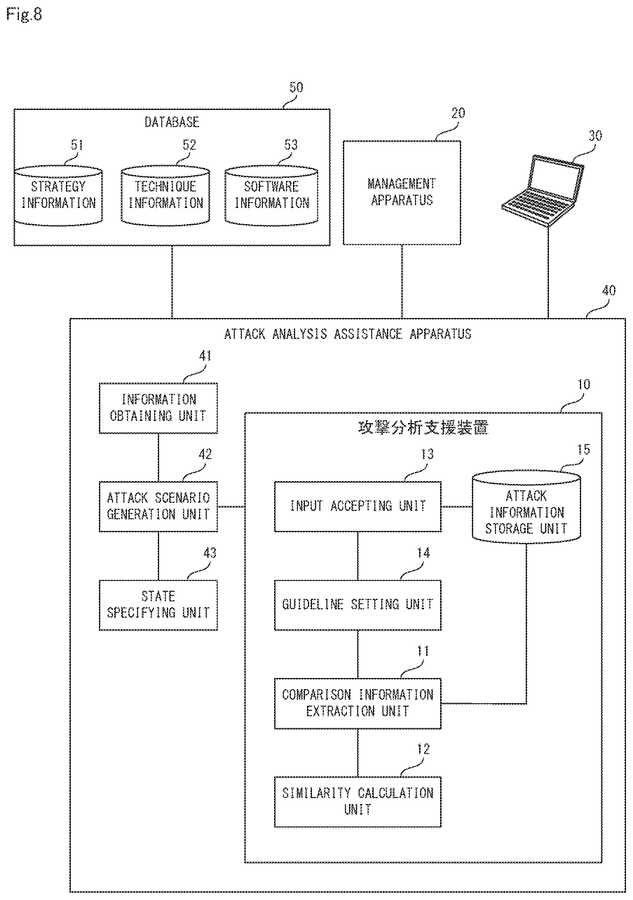

Next, application examples of the attack analysis assistance apparatus 10 according to the example embodiment will be described with reference to FIGS. 8 to 11. FIG. 8 is a configuration diagram showing an application example of the attack analysis assistance apparatus according to the example embodiment.

As shown in FIG. 8, in this example, the attack analysis assistance apparatus 10 constitutes a portion of a security training assistance apparatus 40. The security training assistance apparatus 40 is an apparatus that generates an attack scenario of a targeted attack carried out by a virtual attacker, and assists with training for a targeted attack.

As shown in FIG. 8, the security training assistance apparatus 40 includes an information obtaining unit 41, an attack scenario generation unit 42, and a state specifying unit 43 in addition to the attack analysis assistance apparatus 10.

The information obtaining unit 41 obtains information for generating an attack scenario from the terminal apparatus 30. The information that is obtained may be information for specifying the number of set processes that make up a targeted attack (hereinafter referred to as “information regarding the number of settings”) and information for specifying an environment in which a scenario is executed (hereinafter referred to as “environment information”).

Specific examples of the environment information include the type of an operating system used in a terminal targeted for an attack, an IP address and a network topology of a terminal targeted for an attack, and the like. In addition, the information obtaining unit 41 can also obtain information for specifying a technique, software, and the like that are adopted by a virtual attacker.

The attack scenario generation unit 42 selects processing that is executed in each process, from a database 50 in which elements of processing executable in processes are registered, until the number of set processes is met, and generates an attack scenario.

Every time a process of a scenario of a targeted attack is generated by the attack scenario generation unit 42, the state specifying unit 43 specifies the state of a virtual attacker and information obtained by the virtual attacker at this time. Note that, as will be described later, the state of the virtual attacker and information obtained by the virtual attacker are specified based on strategies, techniques, and software selected in the processes.

As shown in FIG. 3, the attack scenario is made up of a plurality of processes. A function that is executed in each process is defined by a strategy in the process, a technique that is used in the process, and software required to execute processing of the process.

Thus, strategy information 51 for specifying a strategy candidate in each process, technique information 52 for specifying a candidate for a technique that can be used in each process, and software information 53 for specifying a candidate for software that can be used to execute processing in each process are registered in the database 50.

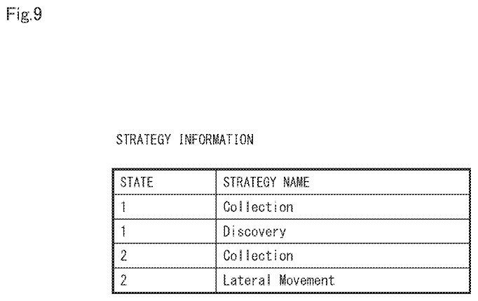

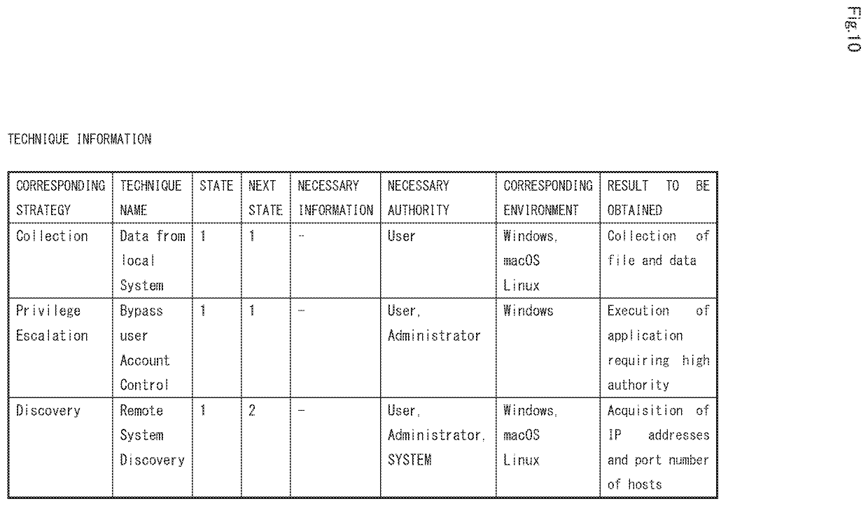

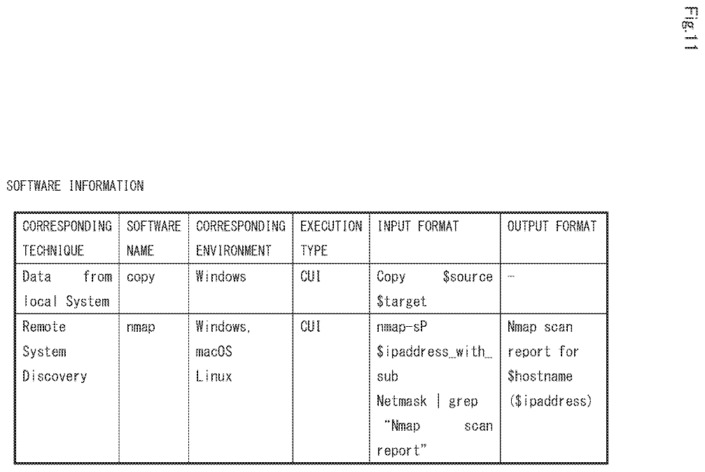

Here, specific examples of information registered in the database 50 and specific examples of processing that is performed by the attack scenario generation unit 42 and the state specifying unit 43 will be described. FIG. 9 is a diagram showing an example of strategy information registered in a database according to an application example. FIG. 10 is a diagram showing an example of technique information registered in a database according to an application example. FIG. 11 is a diagram showing an example of software information registered in a database according to an application example.

As shown in FIG. 9, the strategy information 51 is constituted by a “strategy name” of each strategy and a “state” indicating the state of a virtual attacker when the strategy is adopted. In addition, as shown in FIG. 10, the technique information 52 is constituted, for each technique, by a “corresponding strategy”, a “technique name”, a “state” indicating the state of a virtual attacker when the technique is adopted, a “next state” indicating the state of the virtual attacker after the technique is adopted, “necessary information”, a “necessary authority”, a “corresponding environment”, and a “result to be obtained”. Note that examples of the “necessary information” in FIG. 10 include the above environment information. In addition, the “corresponding environment” may be an environment of a terminal targeted for an operation that is performed by a virtual attacker.

Furthermore, as shown in FIG. 11, the software information 53 is made up of a “corresponding technique”, a “software name”, a “corresponding environment”, an “execution type”, an “input format”, and an “output format”, for each item of software.

The attack scenario generation unit 42 specifies strategies that match the “state” of a virtual attacker specified by the state specifying unit 43, from the strategy information 51 in the database 50, for the respective processes (#=1, 2, . . . ) that make up a targeted attack (see FIG. 3). The attack scenario generation unit 42 then selects a strategy in a process that is to be selected, from the specified strategies, in accordance with a rule set in advance.

Next, the attack scenario generation unit 42 specifies a technique that corresponds to a previously selected strategy and that matches the “state” and “environment information” of the virtual attacker, from the technique information 52 in the database 50. The attack scenario generation unit 42 then selects a technique in the process that is to be selected, from the specified techniques in accordance with a rule set in advance (see FIG. 3).

Next, the attack scenario generation unit 42 specifies software that corresponds to the technique selected earlier, and in which the “environment of a terminal targeted for an operation that is performed by the virtual attacker” matches the “corresponding environment”, from the software information 53 in the database 50, and selects the specified software (see FIG. 3).

In addition, examples of the above rule include a rule that changes in time series and a rule that mimics behaviors of a virtual attacker. Of these, examples of the rule that changes in time series include a rule “a strategy and a technique for expanding an infected area are selected in an early-period process of an attack scenario, a strategy and a technique for discovering important information are selected in an intermediate-period process of the attack scenario, and a strategy and a technique for moving the discovered important information to an external device, and a strategy and a technique for deleting evidence are selected in a later-period process of the attack scenario”. In addition, classification into an early period, an intermediate period, and a later period is performed as appropriate in accordance with the number of set processes.

The strategy for expanding an infected area may be “Lateral Movement”. The technique for expanding an infected area may be “Remote Desktop Protocol” for expanding an infected area using a remote desktop service or “Exploitation of Remote Services” for expanding an infected area using a vulnerability of a remote service (SMB, MySQL, etc.)

The strategy for discovering important information may be “Discovery”. The technique for discovering an important item may be “Remote System Discovery” for searching for a terminal other than a terminal that has been infiltrated in a network environment targeted for invasion, or “File and Directory Discovery” for obtaining a list of files or directories or specific information in a terminal/network that has been infiltrated. In addition, specific examples of “Remote System Discovery” include a ping command and a net view command. Specific examples of “File and Directory Discovery” include a dir command and a tree command.

The strategy for moving discovered important information to an external device may be “Exfiltration”. The technique for moving discovered important information to the outside may be “Exfiltration Over Command and Control Channel” for moving information to an external device on the same route as a communication path of an attack instruction, and “Exfiltration Over Physical Medium” for moving information to an external device via a physical medium. Specific examples of “Exfiltration Over Command and Control Channel” include HTTP GET and email. Specific examples of “Exfiltration Over Physical Medium” include a USB drive and a mobile phone.

The strategy for deleting evidence may be “Defense Evasion”. The technique for deleting evidence may be “Indicator Removal on Host” for deleting a log in which evidence of an attack activity remains and “File Deletion” for deleting a file used in an attack activity. Specific examples of “Indicator Removal on Host” include a wevtutil cl system (deletion of Windows event log). Specific examples of “File Deletion” include a rm command and a del command.

In addition, examples of the rule that represents behaviors of a virtual attacker include a rule “when a strategy and a technique related to perpetuation of an attack have not been performed, a strategy and a technique related to perpetuation of an attack are selected for a terminal in an environment that is currently under attack”.

The strategy related to perpetuation of an attack may be “Persistence”. The technique related to perpetuation of an attack may be “Scheduled Task” for setting, in a scheduled task, execution of a program at a specific time or periodical execution of a program. In addition, specific examples of “Scheduled Task” include a schtasks command and an at command.

A targeted attack is executed interactively. Moreover, there is the possibility that a route for this interactive attack (a connection that uses a TCP session and an authorized account) will be lost due to the system being restarted, a change in authentication information, or the like. Therefore, the virtual attacker adopts a strategy and a technique for maintaining the attack on a terminal that has been infiltrated. The strategy and the technique for maintaining an attack are the above strategy and technique related to perpetuation of an attack. In addition, once the technique related to perpetuation of an attack is executed, the effect thereof continues on the same terminal, and thus the technique is executed only on a terminal that has not been subjected to execution of the technique.

Assume that, for example, a RAT client is operating on a terminal that has been infiltrated, and a RAT server is operating on a terminal of a virtual attacker. In this case, the virtual attacker sends an operation instruction related to an attack over a firewall, and thus, usually, a session is opened from the RAT client side of the terminal that has been infiltrated to the RAT server of the terminal of the virtual attacker. However, when the terminal that has been infiltrated is shut down by an authorized user, the virtual attacker cannot send an operation instruction unless the RAT client is executed after the terminal is restarted. Therefore, the virtual attacker adds the setting “the RAT client is executed when the terminal is started” to a scheduled task of the terminal that has been infiltrated, using the above “Scheduled Task”, and executes an attack technique that enables an attack to continue.

When a strategy, a technique, and software are selected by the attack scenario generation unit 42, the state specifying unit 43 specifies the “state” of the selected strategy, and regards the specified “state” as the state of the virtual attacker. In addition, the state specifying unit 43 specifies a “result to be obtained” from the selected technique, and further specifies information that has been obtained by the virtual attacker, based the specified result.

When an end condition is met, an attack scenario is completed. The end condition may be the number of generated processes, that is to say the number of selected processes reaching a set number with respect to strategies, techniques, and software, or the like.

In addition, generating an attack scenario, the attack scenario generation unit 42 adds information regarding execution of an targeted attack to the generated attack scenario, and defines the resultant as attack information (see FIG. 3). The attack scenario generation unit 42 then inputs the attack information to the attack analysis assistance apparatus 10. Note that, information regarding execution of a targeted attack may be added in accordance with a rule set in advance, or may be added by the user.

According to this application example, attack information regarding a virtual targeted attack is automatically created, and the similarity between this virtual targeted attack and an actual targeted attack is presented quantitatively. For this reason, it is easy for the user to execute exercises using an attack that is similar to an actual targeted attack.

### [Physical Configuration]

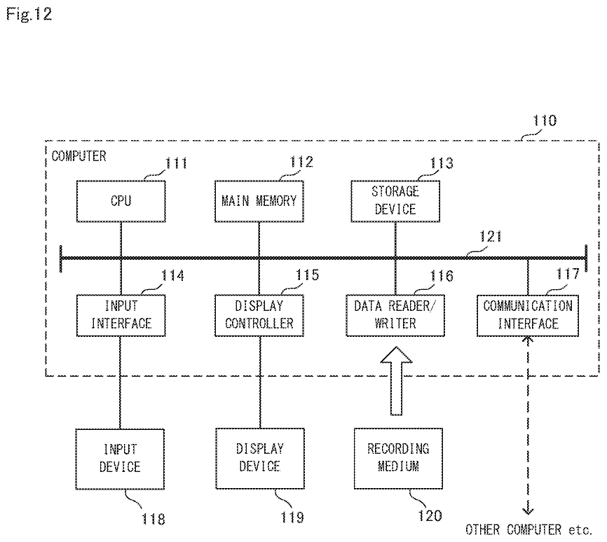

Using FIG. 12, the following describes a computer that realizes the attack analysis assistance apparatus by executing the program according to the example embodiment. FIG. 12 is a block diagram illustrating an example of a computer that realizes the attack analysis assistance apparatus 10 according to the example embodiment.

As illustrated in FIG. 12, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the attack analysis assistance apparatus 10 according to the example embodiment can also be realized by using items of hardware that respectively correspond to the components rather than the computer in which the program is installed. Furthermore, a part of the attack analysis assistance apparatus 10 may be realized by the program, and the remaining part of the attack analysis assistance apparatus 10 may be realized by hardware.

A part or an entirety of the above-described example embodiment can be represented by (Supplementary Note 1) to (Supplementary Note 12) described below but is not limited to the description below.

### (Supplementary Note 1)

An attack analysis assistance apparatus comprising:

a comparison information extraction unit that extracts, from information regarding a plurality of targeted attacks, respective pieces of comparison information that are related to a set guideline and are to be used for comparison; and

a similarity calculation unit that receives, as input, the pieces of comparison information extracted from the information regarding the plurality of targeted attacks, and calculates a similarity between the plurality of targeted attacks.

### (Supplementary Note 2)

The attack analysis assistance apparatus according to supplementary note 1,

wherein the information regarding each of the plurality of targeted attacks includes information regarding an attack procedure in which functions executed in the targeted attack are defined in time series and information regarding execution of the targeted attack, and

at least one of a function executed in a targeted attack, a timing when a targeted attack was executed, and whether or not a targeted attack was executed successfully is set as the guideline.

### (Supplementary Note 3)

The attack analysis assistance apparatus according to supplementary note 2, further comprising

a guideline setting unit that sets, as the guideline, at least one of a function executed in a targeted attack, a timing when a targeted attack was executed, and whether or not a targeted attack was executed successfully.

### (Supplementary Note 4)

The attack analysis assistance apparatus according to supplementary note 3,

wherein, when two or more guidelines are set, the guideline setting unit further sets a weight for each of the two or more set guidelines,

the comparison information extraction unit extracts the pieces of comparison information from the information regarding the plurality of targeted attacks, for each of the two or more guidelines, and

the similarity calculation unit calculates the similarities for the two or more respective guidelines, and calculates an integrated similarity using the similarities and weights for the respective guidelines.

### (Supplementary Note 5)

An attack analysis assistance method comprising:

a comparison information extraction step of extracting, from information regarding a plurality of targeted attacks, respective pieces of comparison information that are related to a set guideline and are to be used for comparison; and

a similarity calculation step of receiving, as input, the pieces of comparison information extracted from the information regarding the plurality of targeted attacks, and calculating a similarity between the plurality of targeted attacks.

### (Supplementary Note 6)

The attack analysis assistance method according to supplementary note 5,

wherein the information regarding each of the plurality of targeted attacks includes information regarding an attack procedure in which functions executed in the targeted attack are defined in time series and information regarding execution of the targeted attack, and

at least one of a function executed in a targeted attack, a timing when a targeted attack was executed, and whether or not a targeted attack was executed successfully is set as the guideline.

### (Supplementary Note 7)

The attack analysis assistance method according to supplementary note 6, further comprising

a guideline setting step of setting, as the guideline, at least one of a function executed in a targeted attack, a timing when a targeted attack was executed, and whether or not a targeted attack was executed successfully.

### (Supplementary Note 8)

The attack analysis assistance method according to according to supplementary note 7,

wherein, in the guideline setting step, when two or more guidelines are set, further setting a weight for each of the two or more set guidelines,

in the comparison information extraction step, extracting the pieces of comparison information from the information regarding the plurality of targeted attacks, for each of the two or more guidelines, and,

in the similarity calculation step, calculating the similarities for the two or more respective guidelines, and calculating an integrated similarity using the similarities and weights for the respective guidelines.

### (Supplementary Note 9)

A computer-readable recording medium that includes a program recorded thereon, the program including instructions that causes a computer to carry out:

a comparison information extraction step of extracting, from information regarding a plurality of targeted attacks, respective pieces of comparison information that are related to a set guideline and are to be used for comparison; and

a similarity calculation step of receiving, as input, the pieces of comparison information extracted from the information regarding the plurality of targeted attacks, and calculating a similarity between the plurality of targeted attacks.

### (Supplementary Note 10)

The computer-readable recording medium according to supplementary note 9,

wherein the information regarding each of the plurality of targeted attacks includes information regarding an attack procedure in which functions executed in the targeted attack are defined in time series and information regarding execution of the targeted attack, and

at least one of a function executed in a targeted attack, a timing when a targeted attack was executed, and whether or not a targeted attack was executed successfully is set as the guideline.

### (Supplementary Note 11)

The computer-readable recording medium according to supplementary note 10,

wherein the program further includes an instruction that causes the computer to carry out

a guideline setting step of setting, as the guideline, at least one of a function executed in a targeted attack, a timing when a targeted attack was executed, and whether or not a targeted attack was executed successfully.

### (Supplementary Note 12)

The computer-readable recording medium according to supplementary note 11,

Wherein, in the guideline setting step, when two or more guidelines are set, further setting a weight for each of the two or more set guidelines,

in the comparison information extraction step, extracting the pieces of comparison information from the information regarding the plurality of targeted attacks, for each of the two or more guidelines, and,

in the similarity calculation step, calculating the similarities for the two or more respective guidelines, and calculating an integrated similarity using the similarities and weights for the respective guidelines.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the invention, it is possible to present quantitatively a similarity between targeted attacks. The present invention is useful for system for countering the targeted attack.

### REFERENCE SIGNS LIST

10 Attack analysis assistance apparatus
11 Comparison information extraction unit
12 Similarity calculation unit
13 Input accepting unit
14 Guideline setting unit
15 Attack information storage unit
20 Management apparatus
30 Terminal apparatus
40 Security training assistance apparatus
41 Information obtaining unit
42 Attack scenario generation unit
43 State specifying unit
50 Database
51 Strategy information
52 Technique information
53 Software information
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1 An attack analysis assistance apparatus comprising:
at least one memory storing instructions; and
at least one processor configured to execute the instructions to:
extract, from information regarding a plurality of targeted attacks, respective pieces of comparison information that are related to a set guideline and are to be used for comparison; and
receive, as input, the pieces of comparison information extracted from the information regarding the plurality of targeted attacks, and calculate a similarity between the plurality of targeted attacks.

2. The attack analysis assistance apparatus according to claim 1,
wherein the information regarding each of the plurality of targeted attacks includes information regarding an attack procedure in which functions executed in the targeted attack are defined in time series and information regarding execution of the targeted attack, and
at least one of a function executed in a targeted attack, a timing when a targeted attack was executed, and whether or not a targeted attack was executed successfully is set as the guideline.

3. The attack analysis assistance apparatus according to claim 2, further comprising
further at least one processor configured to execute the instructions to:
set, as the guideline, at least one of a function executed in a targeted attack, a timing when a targeted attack was executed, and whether or not a targeted attack was executed successfully.

4. The attack analysis assistance apparatus according to claim 3,
wherein, when two or more guidelines are set, the guideline setting means further sets a weight for each of the two or more set guidelines,
further at least one processor configured to execute the instructions to:
extract the pieces of comparison information from the information regarding the plurality of targeted attacks, for each of the two or more guidelines, and
calculate the similarities for the two or more respective guidelines, and calculates an integrated similarity using the similarities and weights for the respective guidelines.

5. An attack analysis assistance method comprising:
extracting, from information regarding a plurality of targeted attacks, respective pieces of comparison information that are related to a set guideline and are to be used for comparison; and
receiving, as input, the pieces of comparison information extracted from the information regarding the plurality of targeted attacks, and calculating a similarity between the plurality of targeted attacks.

6. The attack analysis assistance method according to claim 5,
wherein the information regarding each of the plurality of targeted attacks includes information regarding an attack procedure in which functions executed in the targeted attack are defined in time series and information regarding execution of the targeted attack, and
at least one of a function executed in a targeted attack, a timing when a targeted attack was executed, and whether or not a targeted attack was executed successfully is set as the guideline.

7. (canceled)

8. The attack analysis assistance method according to according to claim 6,
wherein, in the guideline setting, when two or more guidelines are set, further setting a weight for each of the two or more set guidelines,
in the comparison information extracting, extracting the pieces of comparison information from the information regarding the plurality of targeted attacks, for each of the two or more guidelines, and,
in the similarity calculation, calculating the similarities for the two or more respective guidelines, and calculating an integrated similarity using the similarities and weights for the respective guidelines.

9. A non-transitory computer-readable recording medium that includes a program recorded thereon, the program including instructions that causes a computer to carry out:
extracting, from information regarding a plurality of targeted attacks, respective pieces of comparison information that are related to a set guideline and are to be used for comparison; and
receiving, as input, the pieces of comparison information extracted from the information regarding the plurality of targeted attacks, and calculating a similarity between the plurality of targeted attacks.

10. The non-transitory computer-readable recording medium according to claim 9,
wherein the information regarding each of the plurality of targeted attacks includes information regarding an attack procedure in which functions executed in the targeted attack are defined in time series and information regarding execution of the targeted attack, and
at least one of a function executed in a targeted attack, a timing when a targeted attack was executed, and whether or not a targeted attack was executed successfully is set as the guideline.

11. (canceled)

12. The non-transitory computer-readable recording medium according to claim 10,
wherein, in the guideline setting, when two or more guidelines are set, further setting a weight for each of the two or more set guidelines,
in the comparison information extracting, extracting the pieces of comparison information from the information regarding the plurality of targeted attacks, for each of the two or more guidelines, and,
in the similarity calculation, calculating the similarities for the two or more respective guidelines, and calculating an integrated similarity using the similarities and weights for the respective guidelines.
